(19) United States
(12) Patent Application Publication
(10) Pub. No.: US 2006/0049952 A1
(43) Pub. Date: Mar. 9, 2006

(54) Warning device for container to indicate waterless condition

(76) Inventor: Chin-Lai Su, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/934,125

(22) Filed: Sep. 7, 2004

(51) Int. Cl. G08B 21/00

(52) U.S. Cl. 340/618

(57) ABSTRACT

A warning device for a container includes a photo-audio drive circuit including a photo-audio IC (integrated circuit), at least one light emitting member connected to the photo-audio IC, a loudspeaker connected to the photo-audio IC, and two exposed metallic contacts each connected to the photo-audio IC. Thus, the warning device provides a photo-audio effect to notify a user that the container is waterless or the water level of the container is under a determined height, so that the user can replenish the water of the container.

### BACKGROUND OF THE INVENTION

1. Field of the Invention

The present invention relates to a warning device, and more particularly to a warning device for a container to indicate a waterless condition of the container.

2. Description of the Related Art

A conventional container in accordance with the prior art shown in FIG. 5 comprises a column 11 having a first end formed with a support seat 110, an optical sensitive resistor 111 mounted in the support seat 110 of the column 11, a cup 12 mounted on the first end of the column 11 and formed with a recess 120, a mercury device 121 containing mercury mounted in the recess 120 of the cup 12, a base 10 mounted on a second end of the column 11, a photo-audio circuit 102 mounted in the base 10 and containing a loudspeaker, at least one LED and a circuit board, and a cover 101 mounted on the base 10 to cover the photo-audio circuit 102.

In operation, when the cup 12 is inclined to a determined angle, the mercury contained in the mercury device 121 slips to expose the optical sensitive resistor 111 which contacts the incident light to conduct the photo-audio circuit 102, so that the photo-audio circuit 102 drives the light emitting member to light and drives the loudspeaker to emit sound so as to provide an amusement effect. Alternatively, when the cup 12 is disposed at a horizontal state, the mercury contained in the mercury device 121 is moved to the original position to encompass the optical sensitive resistor 111 so as to interrupt the photo-audio circuit 102, thereby stopping operation of the photo-audio circuit 102, so that the light emitting member stops lighting and the loudspeaker stops emitting sound.

However, the recess 120 of the cup 12 is designed to have a conic shape to facilitate movement of the mercury. Thus, the mercury cannot slip out of the conical bottom of the recess 120 of the cup 12, so that the optical sensitive resistor 111 cannot contact the incident light to conduct the photo-audio circuit 102, thereby affecting operation of the photo-audio circuit 102.

### SUMMARY OF THE INVENTION

In accordance with the present invention, there is provided a warning device for a container, comprising a photo-audio drive circuit including:
a photo-audio IC (integrated circuit);
at least one light emitting member connected to the photo-audio IC;
a loudspeaker connected to the photo-audio IC; and
two exposed metallic contacts each connected to the photo-audio IC.

The primary objective of the present invention is to provide a warning device for a container to indicate a waterless condition of the container.

Another objective of the present invention is to provide a warning device that provides a photo-audio effect to notify a user that the chamber of the main body is waterless or the water level of the chamber of the main body is under a determined height, so that the user can replenish the water of the chamber of the main body.

A further objective of the present invention is to provide a warning device, wherein the two exposed metallic contacts function as a switch of the photo-audio IC to control operation of the photo-audio IC by water (or liquid) contact to control operation of the light emitting member and the loudspeaker.

A further objective of the present invention is to provide a warning device, wherein the photo-audio drive circuit is conducted and driven by liquid contact without having to provide a switch or a mercury device to conduct the circuit, thereby saving costs of fabrication.

A further objective of the present invention is to provide a warning device, wherein the photo-audio drive circuit is conducted and driven easily and conveniently, thereby facilitating a user operating the warning device.

Further benefits and advantages of the present invention will become apparent after a careful reading of the detailed description with appropriate reference to the accompanying drawings.

### BRIEF DESCRIPTION OF THE DRAWINGS

FIG. 1 is a block diagram of a photo-audio drive circuit of a warning device in accordance with the preferred embodiment of the present invention;

FIG. 2 is a perspective view of a container in accordance with the preferred embodiment of the present invention;

FIG. 3 is a plan cross-sectional view of the container as shown in FIG. 2;

FIG. 4 is a partially enlarged view of the container as shown in FIG. 3; and

FIG. 5 is a plan cross-sectional view of a conventional container in accordance with the prior art.

### DETAILED DESCRIPTION OF THE INVENTION

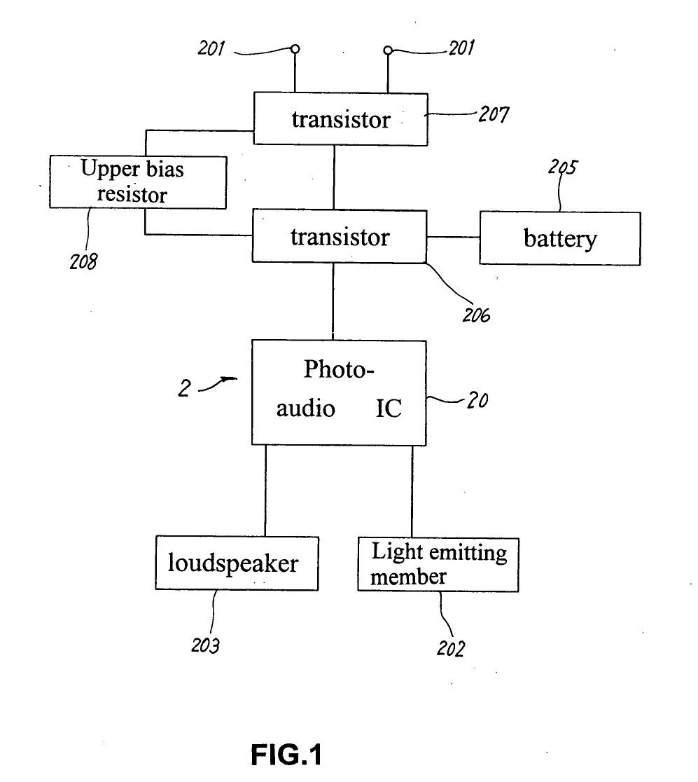

Referring to the drawings and initially to FIG. 1, a warning device in accordance with the preferred embodiment of the present invention comprises a photo-audio drive circuit 2 including a photo-audio IC (integrated circuit) 20, a light emitting member 202 connected to the photo-audio IC 20, a loudspeaker 203 connected to the photo-audio IC 20, a first transistor 206 connected to the photo-audio IC 20, a battery 204 connected to the first transistor 206 to supply an electric power to the first transistor 206, a second transistor 207 connected to the first transistor 206, an upper bias resistor 208 connected between the first transistor 206 and the second transistor 207, and two exposed metallic contacts 201 each connected to the second transistor 207, wherein the two exposed metallic contacts 201 are isolated from with each other when not contacting water to form an interrupted state, so that the base of the second transistor 207 obtains a positive voltage from the upper bias resistor 208 to push the first transistor 206 at a saturated state to work so as to transmit the positive voltage to the photo-audio IC 20 which drives the light emitting member 202 to light and drives the loudspeaker 203 to emit sound.

Alternatively, the two exposed metallic contacts 201 are electrically connected with each other by conduction of water molecules when contacting water, so that the second transistor 207 forms a lower bias resistor having a resistance smaller than that of the upper bias resistor 208 to interrupt the positive voltage of the base of the second transistor 207 to stop operation of the first transistor 206 at a saturated state to stop operation of the photo-audio IC 20 such that the light emitting member 202 stops lighting and the loudspeaker 203 stops emitting sound.

Thus, the two exposed metallic contacts 201 function as a switch of the photo-audio IC 20 to control operation of the photo-audio IC 20 by water (or liquid) contact so as to control operation of the light emitting member 202 and the loudspeaker 203.

In such a manner, when the two exposed metallic contacts 201 contact the water, the two exposed metallic contacts 201 are electrically connected with each other, and the photo-audio drive circuit 2 is disposed at an interrupted state to stop operation of the photo-audio IC 20 such that the light emitting member 202 stops lighting and the loudspeaker 203 stops emitting sound.

Alternatively, when the two exposed metallic contacts 201 are not in contact with the water, the two exposed metallic contacts 201 are isolated from with each other, and the photo-audio drive circuit 2 is disposed at a connected state, so that the photo-audio IC 20 is operated to drive the light emitting member 202 to light and to drive the loudspeaker 203 to emit sound.

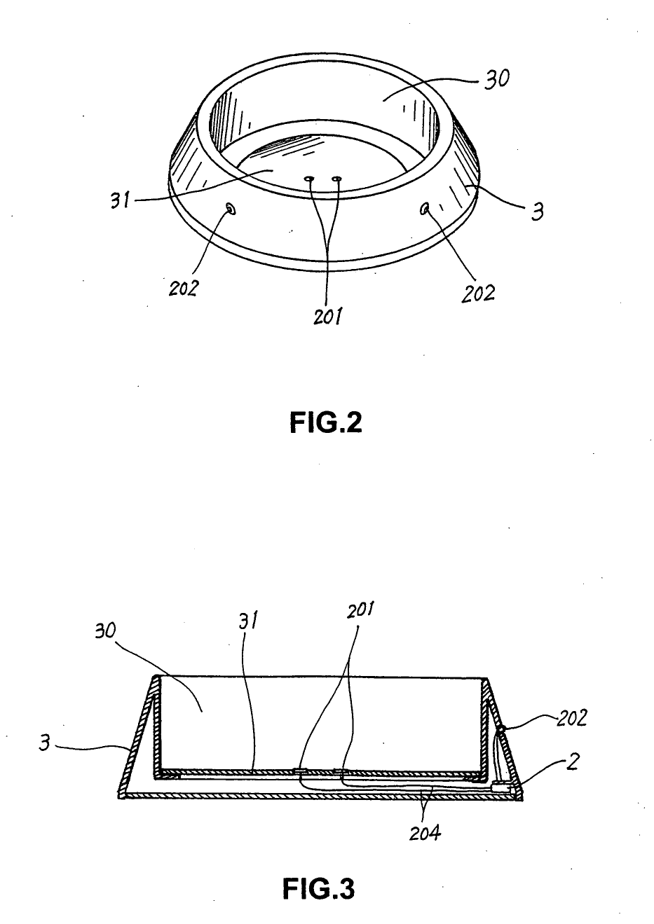

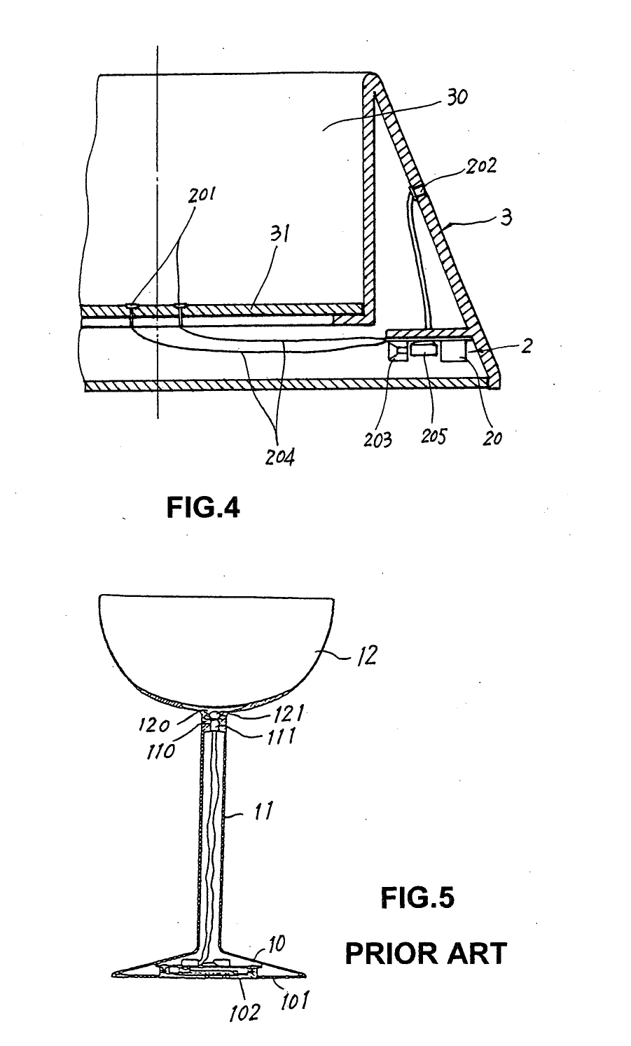

Referring to FIGS. 2-4, a container in accordance with the preferred embodiment of the present invention comprises a main body 3 having an inside formed with a chamber 30 containing water or liquid therein, and a bottom plate 31 mounted on a bottom of the main body 3. The photo-audio drive circuit 2 of the warning device is mounted in the main body 3. Each of the two metallic contacts 201 of the photo-audio drive circuit 2 is extended through the bottom plate 31 and extended into and exposed in the chamber 30 of the main body 3. Each of the two metallic contacts 201 of the photo-audio drive circuit 2 is connected to the photo-audio IC 20 by a conducting wire 204. The photo-audio drive circuit 2 includes a plurality of light emitting members 202 each mounted on a peripheral wall of the main body 3 and each connected to the photo-audio IC 20.

In operation, when the chamber 30 of the main body 3 contains water therein, the two exposed metallic contacts 201 are electrically connected with each other by conduction of the water molecules when contacting water, and the photo-audio drive circuit 2 is disposed at an interrupted state to stop operation of the photo-audio IC 20 such that the light emitting member 202 stops lighting and the loudspeaker 203 stops emitting sound.

Alternatively, when the chamber 30 of the main body 3 is waterless or the water level of the chamber 30 of the main body 3 is lower than the height of the two exposed metallic contacts 201, that is, the two exposed metallic contacts 201 are not in contact with the water, the two exposed metallic contacts 201 are isolated from with each other, and the photo-audio drive circuit 2 is disposed at a connected state, so that the photo-audio IC 20 is operated to drive the light emitting member 202 to light and to drive the loudspeaker 203 to emit sound.

Accordingly, the warning device provides a photo-audio effect to notify a user that the chamber 30 of the main body 3 is waterless or the water level of the chamber 30 of the main body 3 is under a determined height, so that the user can replenish the water of the chamber 30 of the main body 3. In addition, the two exposed metallic contacts 201 function as a switch of the photo-audio IC 20 to control operation of the photo-audio IC 20 by water (or liquid) contact so as to control operation of the light emitting member 202 and the loudspeaker 203. Further, the photo-audio drive circuit 2 is conducted and driven by liquid contact without having to provide a switch or a mercury device to conduct the circuit, thereby saving costs of fabrication. Further, the photo-audio drive circuit 2 is conducted and driven easily and conveniently, thereby facilitating a user operating the warning device.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A warning device for a container, comprising a photo-audio drive circuit including:
a photo-audio IC (integrated circuit);
at least one light emitting member connected to the photo-audio IC;
a loudspeaker connected to the photo-audio IC; and
two exposed metallic contacts each connected to the photo-audio IC.

2. The warning device in accordance with claim 1, wherein when the two exposed metallic contacts contact water, the two exposed metallic contacts are electrically connected with each other, and the photo-audio drive circuit is disposed at an interrupted state to stop operation of the photo-audio IC such that the light emitting member stops lighting and the loudspeaker stops emitting sound.

3. The warning device in accordance with claim 1, wherein when the two exposed metallic contacts are not in contact with the water, the two exposed metallic contacts are isolated from with each other, and the photo-audio drive circuit is disposed at a connected state, so that the photo-audio IC is operated to drive the light emitting member to light and to drive the loudspeaker to emit sound so as to provide a waterless warning effect.

4. The warning device in accordance with claim 1, wherein the photo-audio IC has a side connected to the two exposed metallic contacts.

5. The warning device in accordance with claim 1, wherein the two exposed metallic contacts are extended outward from a side of the photo-audio IC.

6. The warning device in accordance with claim 1, wherein the two exposed metallic contacts are mounted on a bottom of a container and are extended into and exposed in an inside of the container.

7. The warning device in accordance with claim 1, wherein the two exposed metallic contacts function as a switch of the photo-audio IC to control operation of the photo-audio IC by liquid contact so as to control operation of the light emitting member and the loudspeaker.
